(19) United States
(12) Patent Application Publication
(10) Pub. No.: US 2020/0374971 A1
(43) Pub. Date: Nov. 26, 2020

(54) METHOD FOR CONTROLLING A DISCONTINUOUS RECEPTION IN DUAL CONNECTIVITY MODE AND A COMMUNICATION NODE THEREOF

(71) Applicant: INDUSTRIAL TECHNOLOGY RESEARCH INSTITUTE, Hsinchu (TW)

(72) Inventors: How-Hang LIU, Taichung City (TW); Chang-Kuo YEH, Hsinchu City (TW)

(73) Assignee: INDUSTRIAL TECHNOLOGY RESEARCH INSTITUTE, Hsinchu (TW)

(21) Appl. No.: 16/536,184

(22) Filed: Aug. 8, 2019

(30) Foreign Application Priority Data
May 22, 2019 (TW) 108117741

(51) Int. Cl. H04W 76/28; H04W 52/02

(52) U.S. Cl. CPC H04W 76/28; H04W 88/06; H04W 52/0212

(57) ABSTRACT

A method for controlling a discontinuous reception (DRX) in a dual connectivity mode comprises: configuring, by a first communication node, a user equipment (UE) that supports a dual connectivity to measure channel qualities of the first and the second communication nodes; configuring, by the first communication node, the UE to enter or leave the DRX on the first communication node, according to the channel qualities of the first and the second communication nodes which feedbacks from the UE; and configuring, by the first communication node, the UE to transmit/receive at least one data radio bearer (DRB) through a leg of the second communication node or transmit/receive the DRB through both of a leg of the first communication node and the leg of the second communication node, according to the channel qualities of the first and the second communication nodes.

### CROSS-REFERENCE TO RELATED APPLICATIONS

This non-provisional application claims priority under 35 U.S.C. § 119(a) on Patent Application No(s). 108117741 filed in Republic of China on May 22, 2019, the entire contents of which are hereby incorporated by reference.

### TECHNICAL FIELD

This disclosure relates to a method for controlling a discontinuous reception in a dual connectivity mode and a communication node thereof.

### BACKGROUND

A user equipment (UE) with dual connectivity (DC) capability can be dual-connected with two base stations to form a dual connectivity architecture, which is called as multi-radio dual connectivity (MR-DC). In this situation, one of the base stations (or evolved node B) becomes a master communication node, and the other base station becomes a secondary communication node, and the master communication node has the responsibility to communicate with the UE and coordinate the UE's radio resources with the secondary communication node through a X2 interface

In the dual connectivity mode, the UE only has signaling connection with the master communication node through a radio resource control (RRC), but it has data connection with the master communication node and the secondary communication node. The contents maintained by the RRC connection are related to the radio resources configured to the UE and how the UE uses the radio resources. In a radio bearer (RB) which is used to transmit data, Data radio bearer (DRB) is used to transmit the user's network packet, and signaling radio bearer (SRB) is used to transmit control information of RRC sublayer. With regard to the standard RRC information used to control various radio resource configurations, wherein the radio resource configuration parameter included in the RRC Connection RE configuration procedure includes a discontinuous reception configuration (DRX-Config) field. Discontinuous reception (DRX) is a scheme used in communication networks to conserve battery energy of receiving devices.

It is a research topic to conceive a synergistic operation mechanism for the communication environment with relatively complete infrastructure in the dual connectivity mode.

### SUMMARY

Accordingly, this disclosure provides a method for controlling a discontinuous reception in a dual connectivity mode and a communication node thereof.

According to one or more embodiment of this disclosure, a method for controlling a discontinuous reception (DRX) in a dual connectivity mode is provided, and the method comprises: configuring, by a first communication node, a user equipment (UE) that supports a dual connectivity to measure a channel quality of the first communication node and a channel quality of a second communication node; configuring, by the first communication node, the UE to enter or leave the DRX on the first communication node, according to the channel qualities of the first and the second communication nodes which feedbacks from the UE; and configuring, by the first communication node, the UE to transmit/receive at least one data radio bearer (DRB) through a leg of the second communication node or transmit/receive the DRB through both of a leg of the first communication node and the leg of the second communication node, according to the channel qualities of the first and the second communication nodes.

According to one or more embodiment of this disclosure, a communication node is provided and the communication node comprises a processor coupled to a transceiver for communicating with the user equipment (UE) that supports the dual connectivity, wherein the processor is configured to control the discontinuous reception (DRX) of the UE on the communication node. The processor configures the UE to measure a channel quality of the communication node and a channel quality of a second communication node. The processor configures the UE to enter or leave the DRX according to the channel quality of the communication node and the channel quality of the second communication node which feedbacks from the UE. The processor configures the UE to transmit/receive at least one data radio bearer (DRB) through a leg of the second communication node or transmit/receive the DRB through both of a leg of the communication node and the leg of the second communication node according to the channel quality of the communication node and the channel quality of the second communication node.

### BRIEF DESCRIPTION OF THE DRAWINGS

The present disclosure will become more fully understood from the detailed description given herein below and the accompanying drawings which are given by way of illustration only and thus are not limitative of the present disclosure and wherein:

FIG. 1 is a schematic view of a communication system according to an embodiment of the present disclosure;

FIG. 2 is a schematic view of a communication node according to an embodiment of the present disclosure;

FIG. 3 is a schematic chart illustrating a usage scenario of the communication system according an embodiment of the present disclosure;

FIG. 4 is a flowchart of a method for controlling a discontinuous reception in a dual connectivity mode according to an embodiment of the present disclosure;

FIGS. 5a-5d are flowcharts of methods for controlling a discontinuous reception in a dual connectivity mode according to several embodiments of the present disclosure;

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

Multi-Radio Dual Connectivity can have multiple different types. For example, communication nodes with the same technical category or different technical categories can be selected as a primary communication node and a secondary communication node. For example, the primary communication node can be an LTE communication node, the secondary communication node can be a 5G New Radio (NR) communication node, and the primary communication node and the secondary communication node form a NR-to-NR Dual Connectivity (NR-DC). For example, the primary communication node can be a Long Term Evolution (LTE) (or called as Evolved Universal Terrestrial Radio Access (E-UTRA)) communication node, the secondary communication node can be an NR communication node, and the primary communication node and the secondary communication node form a LTE-to-NR Dual Connectivity (EN- DC).

In accordance with the present disclosure, a method for controlling a discontinuous reception in a dual connectivity mode and a communication node for operating this method are provided, which can be utilized to control a user equipment (UE) to enter or leave a discontinuous reception (DRX) scheme on a primary communication node, or to adjust the cycle of the DRX of the UE on the primary communication node, and adjust the receiving/sending data path of the UE according to a communication environment of the UE configured by the primary communication node for reducing a power consumption of the primary communication node. In the Radio Resource Control (RRC) information between the primary communication node and the UE, a timer can be set in a discontinuous reception configuration (DRX-Config) field of radio resource configuration parameters included in the RRC Connection RE configuration procedure, the cycle of the DRX can be set, and a subframe (sf) is used as a unit for setting the cycle of the DRX, wherein the time through one subframe is 1 ms. For example, if one DRX is set as 2560 subframes, and 2560 ms is equal to 2.56 seconds.

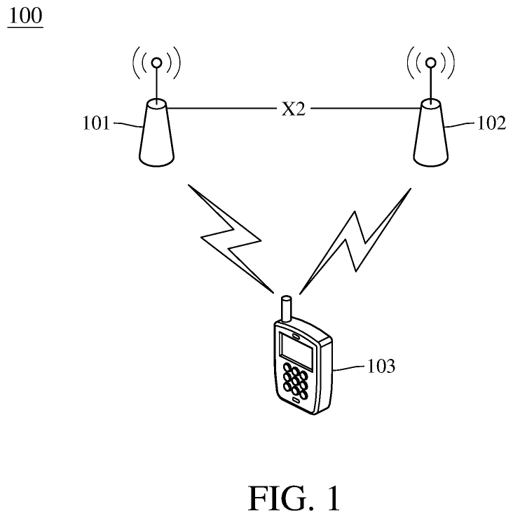

FIG. 1 is a schematic diagram of a communication system 100 that can be implemented according to an embodiment of the present disclosure. The communication system 100 includes a first and a second communication nodes 101 and 102 that are communicated each other by a communication interface X2 to serve at least one user equipment 103. The user equipment 103, for example, can be any one of the following various devices that can perform wireless communication and support Radio Dual Connectivity, but is not limited to: a mobile phone, a computer, a tablet, a vehicle-mounted device, a personal assistant device, a smart television, a robot, or a smart home appliance etc.. The communication system 100 can set one of the two communication nodes as a primary communication node, and the other as a secondary communication node. For example, the first communication node 101 is set as the primary communication node, and the second communication node is 102 is set as the secondary communication node to perform the Radio Dual Connectivity.

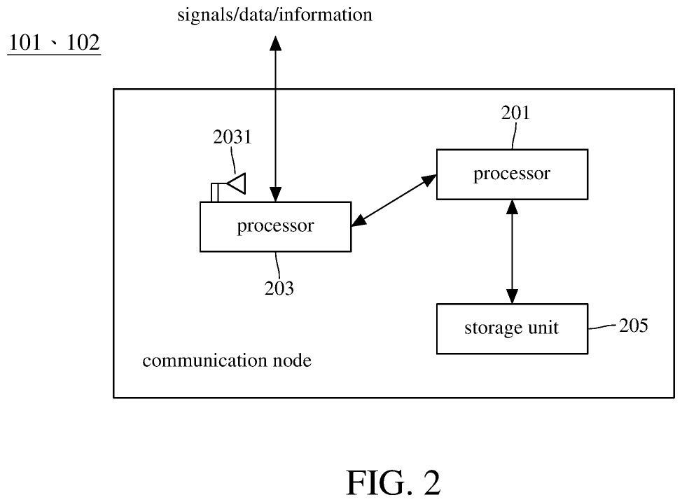

FIG. 2 is a schematic diagram of a communication node according to an embodiment of the present disclosure. The first communication node 101 (or the second communication node 102) at least includes a processor 201, a transceiver 203, and a storage unit 205. The transceiver 203 and the storage unit 205 are electrically connected to the processer 201 respectively, and the transceiver 203 includes an antenna unit 2031, wherein the first communication node 101(or the second communication node 102) transmits and receives data, signals or information through the transceiver 203.

Please refer to FIG. 1 and FIG. 2, the communication node 101 is used as the primary communication node in one embodiment. In one embodiment, the processer 201 of the first communication node 101 controls a discontinuous reception (DRX) of the user equipment 103 on the first communication node 101, and communicates with the user equipment 103 through controlling the transceiver 203. The processer 201 configures the user equipment 103 that supports the dual connectivity to measure a channel quality of the first communication node 101 and a channel quality of a second communication node 102. The processer 201 configures to control the DRX of user equipment 103 on the first communication node 101 according to the channel qualities of the first and the second communication nodes 101 and 102 which feedbacks from the user equipment 103. Moreover, the processer 201 configures the user equipment 103 to transmit/receive at least one data radio bearer (DRB) through a leg of the second communication node 102 or transmit/receive the at least one DRB through both of a leg of the first communication node 101 and the leg of the second communication node 102 according to the channel qualities of the first and the second communication nodes 101 and 102. In another embodiment, the processer 201 controls the discontinuous reception of the user equipment 103 on the first communication node 101 further according to whether the user equipment 103 is configured with a split radio bearer (SRB). In addition, parameters of the DRB path and parameters of the SRB are set through the RRC Connection Reconfiguration procedure in the dual connectivity mode, that is, the parameters of the DRB path and the SRB are configured through the RRC Connection Reconfiguration procedure.

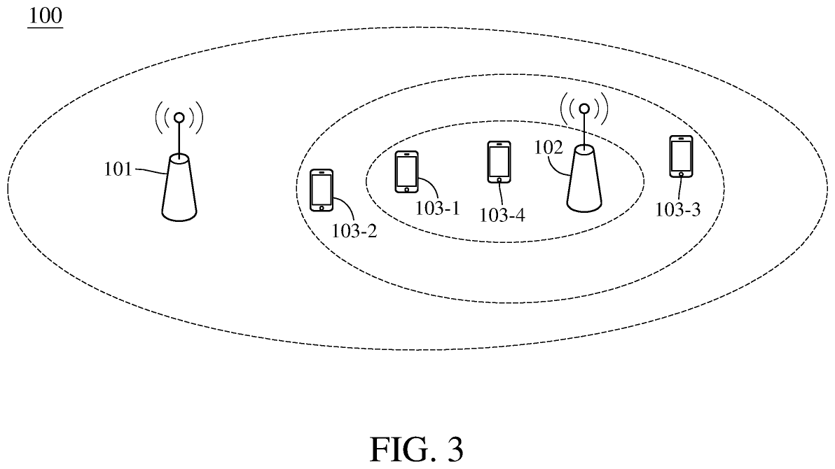

FIG. 3 is a schematic chart illustrating a usage scenario of the communication system 100 according to an embodiment of the present disclosure. The communication system 100 is configured to communicate with the at least one user equipment 103. In addition, in the communication system 100, a channel quality between the at least one user equipment 103 and the first communication node 101 or the second communication node 102 may vary with different possible factors, such as a location of the user equipment 103, a distance or a path between the user equipment 103 and the first communication node 101, a distance or a path between the user equipment 103 and the second communication node 102 etc..

Please in conjunction with FIG. 1, FIG. 2 and FIG. 3, FIG. 3 shows that user equipments 103-1, 103-2, 103-3 and 103-4 are located within a signal coverage area of the first communication node 101 and a signal converge area of the second communication node 102 and the user equipments 103-1, 103-2, 103-3 and 103-4 are respectively located at different locations in the communication system 100. The user equipments 103-1, 103-2 and 103-4 are located between the first communication node 101 and the second communication node 102, the user equipment 103-2 is located closer to the first communication node 101, the user equipment 103-1 and 103-4 are located closer to the second communication node 102, and the user equipment 103-3 is located closer to the second communication node 102 and is located away from the first communication node 101.

In one embodiment of the communication system 100, when the first communication node 101 configures the user equipment to measure the channel quality of the first communication node 101 and the channel quality of the second communication node 102, the first communication node 101 also configures the dual connectivity of the user equipment and the split radio bearer of the user equipment. In an initial state, the first communication node 101 may configure the UE to leave the DRX or enter a short DRX cycle of the DRX and configure the UE to transmit/receive the DRB through both of legs of the first and the second communication nodes 101 and 102. Thereafter, the first communication node 101 will maintain the UE's original state or transform the UE's state to a different state according to the channel qualities of the first and the second communication nodes 101 and 102 which feedbacks from the UE.

For example, in one embodiment, the first communication node 101 configures the user equipment 103-1 to enter the discontinuous reception when the channel qualities of the first and the second communication nodes 101 and 102 measured by the user equipment 103-1 in FIG. 3 are all higher than a preset up-threshold of the communication system 100. Moreover, the first communication node 101 configures the user equipment 103-1 to transmit/receive the at least one DRB through the leg of the second communication node 102. In one embodiment, the processer 201 of the first communicate node 101 configures the UE 103-1 to enter a long DRX cycle of the DRX when the channel quality of the first communication node 101 is higher than a first up-threshold. Moreover, the processer 201 of the first communicate node 101 configures the UE 103-1 to transmit/receive the at least one DRB through the leg of the second communication node 102 when the channel quality of the second communication node 102 is higher than a second up-threshold.

For example, in another embodiment, the first communication node 101 configures the user equipment 103-2 to enter the discontinuous reception when the channel quality of the first communication node 101 measured by the user equipment 103-2 in FIG. 3 is higher than the preset up-threshold of the communication system 100. Moreover, the first communication node 101 configures the user equipment 103-2 to transmit/receive the at least one DRB through both of the legs of the first and the second communication nodes 101 and 102 when the channel quality of the second communication node 102 is lower than a preset low-threshold of the communication system 100. In one embodiment, the processer 201 of the first communicate node 101 configures the UE 103-2 to enter the long DRX cycle when the channel quality of the first communication node 101 is higher than the first up-threshold. Moreover, the processer 201 of the first communicate node 101 configures the UE 103-2 to transmit/receive the at least one DRB through both of the legs of the first and the second communication nodes 101 and 102 when the channel quality of the second communication node 102 is lower than a second low-threshold.

For example, in another embodiment, the first communication node 101 configures the user equipment 103-3 to enter a short discontinuous reception cycle of the discontinuous reception or leave the discontinuous reception when the channel qualities of the first and the second communication nodes 101 and 102 measured by the user equipment 103-3 in FIG. 3 are all lower than the preset low-threshold of the communication system 100. Moreover, the first communication node 101 configures the user equipment 103-3 to transmit/receive the at least one DRB through both of the legs of the first and the second communication nodes 101 and 102. In one embodiment, the processer 201 of the first communicate node 101 configures the UE 103-3 to enter the short DRX cycle or leave the discontinuous reception when the channel quality of the first communication node 101 is lower than a first low-threshold and the channel quality of the second communication node 102 is lower than the second low-threshold. Moreover, the processer 201 of the first communication node 101 configures the UE 103-3 to transmit/receive the at least one DRB through both of the legs of the first and the second communication nodes 101 and 102.

For example, in another embodiment, the first communication node 101 configures the user equipment 103-4 to enter the discontinuous reception when the channel quality of the first communication node 101 measured by the user equipment 103-4 in FIG. 3 is lower than the preset low-threshold of the communication system 100, the channel quality of the second communication node 102 measured by the user equipment 103-4 in FIG. 3 is higher than the preset up-threshold and the UE 103-4 is configured with the split signaling radio bearer (SRB). Moreover, the first communication node 101 configures the user equipment 103-4 to transmit/receive the at least one DRB through the leg of the second communication node 102. In one embodiment, the processer 201 of the first communicate node 101 configures the UE 103-4 to enter the long DRX cycle of the DRX when the channel quality of the first communication node 101 is lower than the first low-threshold, the channel quality of the second communication node 102 is higher than the second up-threshold and the UE 103-4 is configured with the split signaling radio bearer (SRB). Moreover, the processer 201 of the first communication node 101 configures the UE 103-4 to transmit/receive the at least one DRB through the leg of the second communication node 102.

For example, in another embodiment, the first communication node 101 configures the user equipment 103-4 to enter the short discontinuous reception cycle or leave the discontinuous reception when the channel quality of the first communication node 101 measured by the user equipment 103-4 in FIG. 3 is lower than the preset low-threshold of the communication system 100, the channel quality of the second communication node 102 measured by the user equipment 103-4 in FIG. 3 is higher than the preset up-threshold and the UE 103-4 is not configured with the split signaling radio bearer (SRB). Moreover, the first communication node 101 configures the user equipment 103-4 to transmit/receive the at least one DRB through the leg of the second communication node 102. In one embodiment, the processer 201 of the first communicate node 101 configures the UE 103-4 to enter the short discontinuous reception cycle or leave the discontinuous reception when the channel quality of the first communication node 101 is lower than the first low-threshold, the channel quality of the second communication node 102 is higher than the second up-threshold and the UE 103-4 is not configured with the split signaling radio bearer (SRB). Moreover, the processer 201 of the first communicate node 101 configures the UE 103-4 to transmit/receive the at least one DRB through the leg of the second communication node 102.

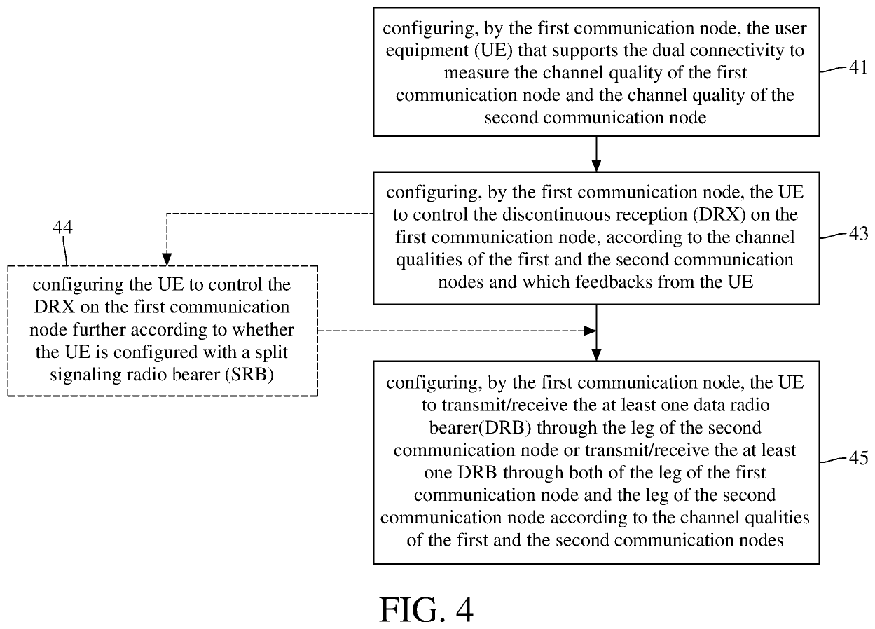

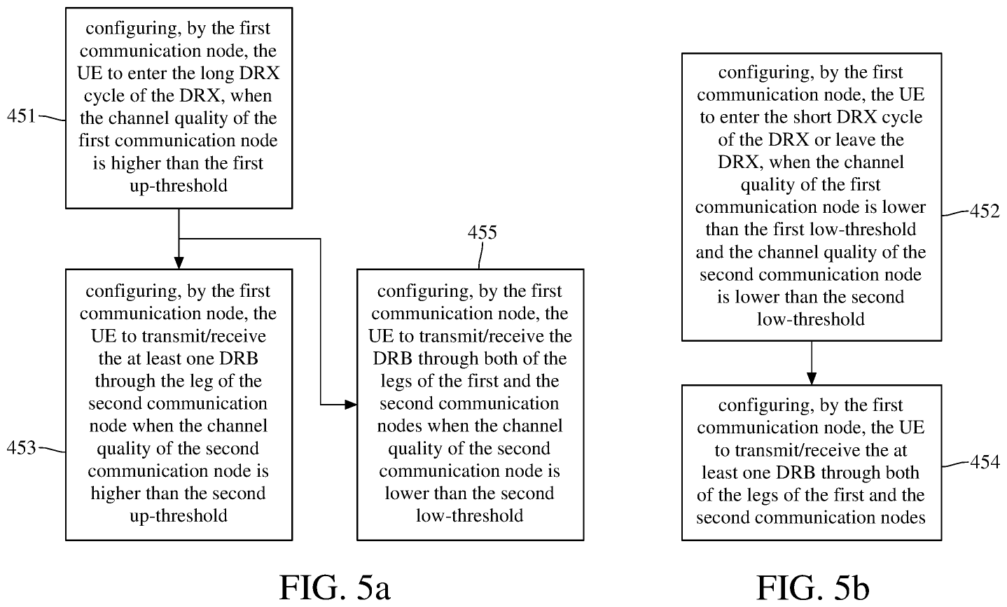

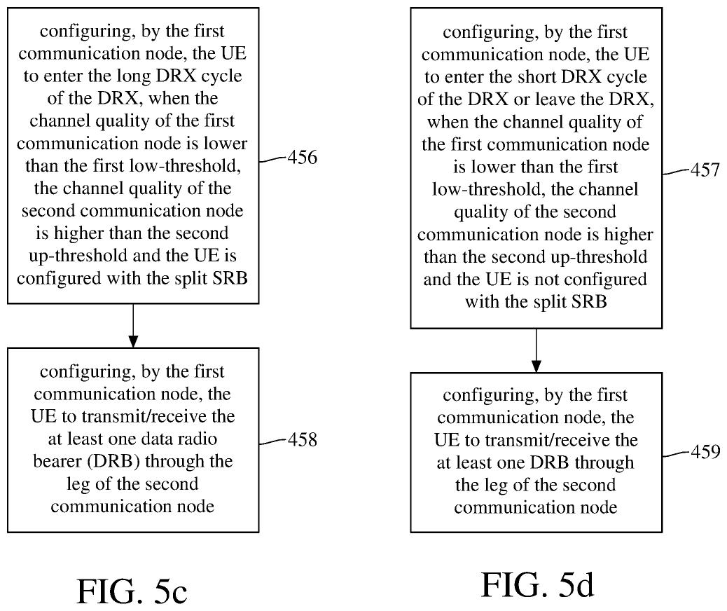

FIG. 4, FIG. 5a, FIG. 5b, FIG. 5c, and FIG. 5d illustrate flowcharts of methods for controlling a discontinuous reception in a dual connectivity mode according to several embodiments of the present disclosure, and the flowcharts according to possible embodiments of the present disclosure will be described in conjunction with FIG. 1 and FIG.4.

As shown in FIG.4, Step 41 is configuring, by the first communication node 101, the user equipment 103 that supports the dual connectivity to measure the channel quality of the first communication node 101 and the channel quality of the second communication node 102, and Step 43 is configuring, by the first communication node 101, the UE 103 to control the DRX on the first communication node 101, according to the channel qualities of the first and the second communication nodes 101 and 102 which feedbacks from the UE 103, and Step 45 is configuring, by the first communication node 101, the UE 103 to transmit/receive the at least one data radio bearer (DRB) through the leg of the second communication node 102 or transmit/receive the at least one DRB through both of the leg of the first communication node 101 and the leg of the second communication node 102 according to the channel qualities of the first and the second communication nodes 101 and 102. In another embodiment, Step 44 is configuring the UE 103 to control the DRX on the first communication node 101 further according to whether the UE 103 is configured with a split signaling radio bearer (SRB).

The flowcharts of performing conversion setting between different states according to embodiments of the present disclosure are illustrated as follows. Please refer to an embodiment shown in FIG.5a, Step 451 is configuring, by the first communication node, the UE to enter the long DRX cycle of the DRX, when the channel quality of the first communication node is higher than the first up-threshold, and Step 453 is configuring, by the first communication node, the UE to transmit/receive the at least one data radio bearer (DRB) through the leg of the second communication node when the channel quality of the second communication node is higher than the second up-threshold, and Step 455 is configuring, by the first communication node, the UE to transmit/receive the DRB through both of the legs of the first and the second communication nodes when the channel quality of the second communication node is lower than the second low-threshold.

Please refer to an embodiment shown in FIG.5b, Step 452 is configuring, by the first communication node, the UE to enter the short DRX cycle of the DRX or leave the DRX, when the channel quality of the first communication node is lower than the first low-threshold and the channel quality of the second communication node is lower than the second low-threshold, and Step 454 is configuring, by the first communication node, the UE to transmit/receive the at least one DRB through both of the legs of the first and the second communication nodes.

Please refer to an embodiment shown in FIG.5c, Step 456 is configuring, by the first communication node, the UE to enter the long DRX cycle of the DRX, when the channel quality of the first communication node is lower than the first low-threshold, the channel quality of the second communication node is higher than the second up-threshold and the UE is configured with the split SRB, and Step 458 is configuring, by the first communication node, the UE to transmit/receive the at least one data radio bearer (DRB) through the leg of the second communication node.

Please refer to an embodiment shown in FIG. 5d, Step 457 is configuring, by the first communication node, the UE to enter the short DRX cycle of the DRX or leave the DRX, when the channel quality of the first communication node is lower than the first low-threshold, the channel quality of the second communication node is higher than the second up-threshold and the UE is not configured with the split SRB, and Step 459 is configuring, by the first communication node, the UE to transmit/receive the at least one data radio bearer (DRB) through the leg of the second communication node.

The foregoing method for controlling the discontinuous reception in dual connectivity and the communication node for operating the method according to the present disclosure, which can control the user equipment (UE) to enter or leave the discontinuous reception (DRX) on the primary communication node, or to adjust the cycle of the DRX of the UE on the primary communication node, and adjust the receiving/ sending data path of the UE according to the communication environment of the UE configured by the primary communication node for reducing the power consumption of the primary communication node.

What is claimed is:

1. A method for controlling a discontinuous reception (DRX) in a dual connectivity mode, comprising:
configuring, by a first communication node, a user equipment (UE) that supports a dual connectivity to measure a channel quality of the first communication node and a channel quality of a second communication node;
configuring, by the first communication node, the UE to enter or leave the DRX on the first communication node, according to the channel qualities of the first and the second communication nodes which feedbacks from the UE; and
configuring, by the first communication node, the UE to transmit/receive at least one data radio bearer (DRB) through a leg of the second communication node or transmit/receive the at least one DRB through both of a leg of the first communication node and the leg of the second communication node according to the channel qualities of the first and the second communication nodes.

2. The method in claim 1, wherein configuring the UE to enter or leave the DRX on the first communication node is further according to whether the UE is configured with a split signaling radio bearer (SRB).

3. The method in claim 1, further comprising:
configuring, by the first communication node, the UE to enter a long DRX cycle of the DRX, when the channel quality of the first communication node is higher than a first up-threshold; and
configuring, by the first communication node, the UE to transmit/receive at least one data radio bearer (DRB) through the leg of the second communication node when the channel quality of the second communication node is higher than a second up-threshold.

4. The method in claim 1, further comprising:
configuring, by the first communication node, the UE to enter a short DRX cycle of the DRX or leave the DRX, when the channel quality of the first communication node is lower than a first low-threshold and the channel quality of the second communication node is lower than a second low-threshold; and
configuring, by the first communication node, the UE to transmit/receive the DRB through both of the legs of the first and the second communication nodes.

5. The method in claim 1, further comprising:
configuring, by the first communication node, the UE to enter a long DRX cycle of the DRX, when the channel quality of the first communication node is higher than a first up-threshold; and
configuring, by the first communication node, the UE to transmit/receive the DRB through both of the legs of the first and the second communication nodes when the channel quality of the second communication node is lower than a second low-threshold.

6. The method in claim 2, further comprising:
configuring, by the first communication node, the UE to enter a long DRX cycle of the DRX, when the channel quality of the first communication node is lower than a first low-threshold, the channel quality of the second communication node is higher than a second up-threshold and the UE is configured with the split SRB; and
configuring, by the first communication node, the UE to transmit/receive at least one data radio bearer (DRB) through the leg of the second communication node.

7. The method in claim 2, further comprising:
configuring, by the first communication node, the UE to enter a short DRX cycle of the DRX or leave the DRX, when the channel quality of the first communication node is lower than a first low-threshold, the channel quality of the second communication node is higher than a second up-threshold and the UE is not configured with the split SRB; and
configuring, by the first communication node, the UE to transmit/receive at least one data radio bearer (DRB) through the leg of the second communication node.

8. A communication node, comprising:
a processor coupled to a transceiver for communicating with a user equipment (UE) that supports a dual connectivity mode, wherein the processor is configured to control a discontinuous reception (DRX) of the user equipment on the communication node, and the control of the DRX of the processor comprising:
configuring the UE to measure a channel quality of the communication node and a channel quality of a second communication node;
configuring the UE to enter or leave the DRX, according to the channel quality of the communication node and the channel quality of the second communication node which feedbacks from the UE; and
configuring the UE to transmit/receive at least one data radio bearer (DRB) through a leg of the second communication node or transmit/receive the DRB through both of a leg of the communication node and the leg of the second communication node, according to the channel quality of the communication node and the channel quality of the second communication node.

9. The communication node in claim 8, wherein configuring the UE to enter or leave the DRX is further according to whether the UE is configured with a split signaling radio bearer (SRB).

10. The communication node in claim 8, wherein the control of the DRX of the processor further comprising:
configuring the UE to enter a long DRX cycle of the DRX when the channel quality of the communication node is higher than a first up-threshold; and
configuring the UE to transmit/receive at least one data radio bearer (DRB) through the leg of the second communication node when the channel quality of the second communication node is higher than a second up-threshold.

11. The communication node in claim 8, wherein the control of the DRX of the processor further comprising:
configuring the UE to enter a short DRX cycle of the DRX or leave the DRX when the channel quality of the communication node is lower than a first low-threshold and the channel quality of the second communication node is lower than a second low-threshold; and
configuring the UE to transmit/receive the DRB through both of the leg of the communication node and leg of the second communication node.

12. The communication node in claim 8, wherein the control of the DRX of the processor further comprising:
configuring the UE to enter a long DRX cycle of the DRX when the channel quality of the communication node is higher than a first up-threshold; and
configuring the UE to transmit/receive the DRB through both of the leg of the communication node and the leg of the second communication node when the channel quality of the second communication node is lower than a second low-threshold.

13. The communication node in claim 9, wherein the control of the DRX of the processor further comprising:
configuring the UE to enter a long DRX cycle of the DRX, when the channel quality of the communication node is lower than a first low-threshold, the channel quality of the second communication node is higher than a second up-threshold and the UE is configured with the split SRB; and
configuring the UE to transmit/receive at least one data radio bearer (DRB) through the leg of the second communication node.

14. The communication node in claim 9, wherein the control of the DRX of the processor further comprising:
configuring the UE to enter a short DRX cycle of the DRX or leave the DRX when the channel quality of the communication node is lower than a first low-threshold, the channel quality of the second communication node is higher than a second up-threshold and the UE is not configured with the split SRB; and
configuring the UE to transmit/receive at least one data radio bearer (DRB) through the leg of the second communication node.
